(19) United States
(12) Patent Application Publication
(10) Pub. No.: US 2023/0356475 A1
(43) Pub. Date: Nov. 9, 2023

(54) COMPOSTABLE INSTALLATION TOOL FOR ATTACHING DEVICES TO SURFACES OF SMARTPHONES AND SMARTPHONE CASES

(71) Applicant: Gang Hu, Dongguan (CN)

(72) Inventor: Gang Hu, Dongguan (CN)

(21) Appl. No.: 18/313,149

(22) Filed: May 5, 2023

Related U.S. Application Data
(60) Provisional application No. 63/338,594, filed on May 5, 2022.

(51) Int. Cl. B29C 65/78; B65D 65/46; B65D 1/34

(52) U.S. Cl. CPC B29C 65/7811; B29C 65/7844; B65D 1/34; B65D 65/466

(57) ABSTRACT

This disclosure is directed to installation tools for installing objects, such as screen protectors and decals, to the surfaces of mobile devices, such as smartphones, tablet computers, and mobile device cases. The installation tool provides precision installation of the objects to the surfaces of mobile devices. The installation tool is composed of biodegradable materials, such as sugarcane and/or bamboo pulp.

### CROSS-REFERENCE TO RELATED APPLICATION

1)This application claims the benefit of Provisional Application 63/338,594 filed May 5, 2022.

### TECHNICAL FIELD

2)This disclosure is directed to the industry of mobile device accessories, and in particular, to compostable installation tools for the precise installation of screen protectors and decals to surfaces of mobile devices and mobile device cases.

### BACKGROUND

3)Since the advent of smartphones, tablets, and other mobile devices, mobile screen protectors have been a staple product in the mobile accessories industry. The most common complaint with mobile screen protectors, for example, is the inability to consistently apply the screen protectors with the edges accurately aligned with the edges of the touchscreens of the mobile device and without blemishes such as bubbles from air pockets that can form between the screen protector and the touchscreen.

4)In recent years, systems for installing screen protectors to the touchscreens of mobile devices were created as value-added solutions to minimize surface defects, and to reduce the time required to apply screen protectors to touchscreens of smartphones or to other types of mobile devices. However, once these screen installation systems have been used, such as just after being used to apply a screen protector, these systems are typically disposed of in the trash and become an environmental hazard.

### SUMMARY

5)This disclosure is directed to installation tools for installing devices on the surfaces of mobile devices, such as smartphones, tablet computers, and mobile device cases. In one aspect, the installation tool provides precision installation of mobile screen protectors and similar devices to touchscreens of mobile devices and installation of decals to the back surfaces of mobile devices or mobile device cases. The installation tool is composed of natural biodegradable decomposable materials, such as sugarcane and/or bamboo pulp. Since the installation tools are biodegradable, the installation tools may be classified as eco-friendly and composted accordingly.

### BRIEF DESCRIPTION OF THE DRAWINGS

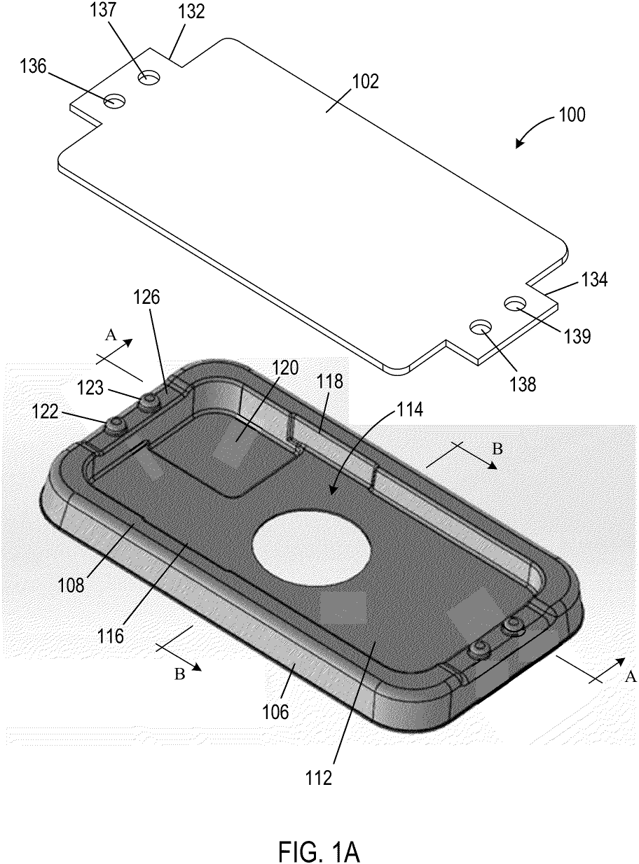

6)FIG. 1A shows an isometric view of an example installation tool.

7)FIG. 1B shows a cross-sectional view of an installation tray of the installation tool shown in FIG. 1A.

8)FIG. 1C shows a cross-sectional view of the installation tray shown in FIG. 1A.

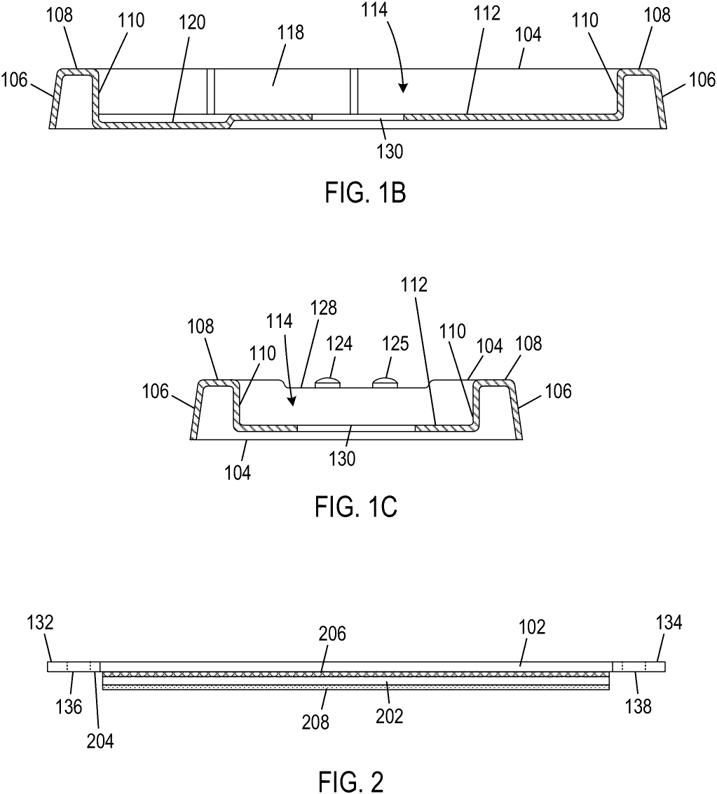

9)FIG. 2 shows an example side elevation view of an applicator of the installation tool shown in FIG. 1A.

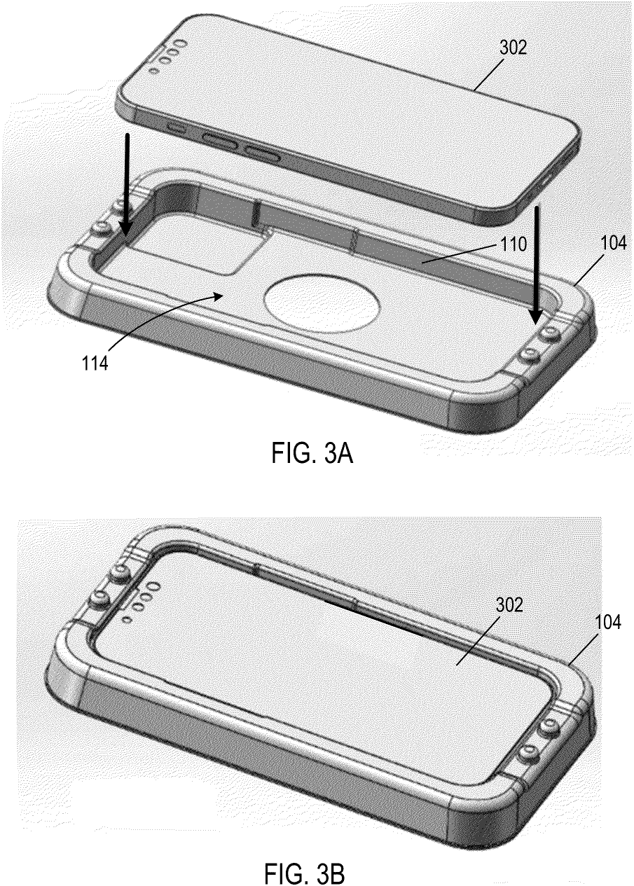

10)FIGS. 3A-3B show an example of placing a mobile phone in a form-fitting container of the installation tray.

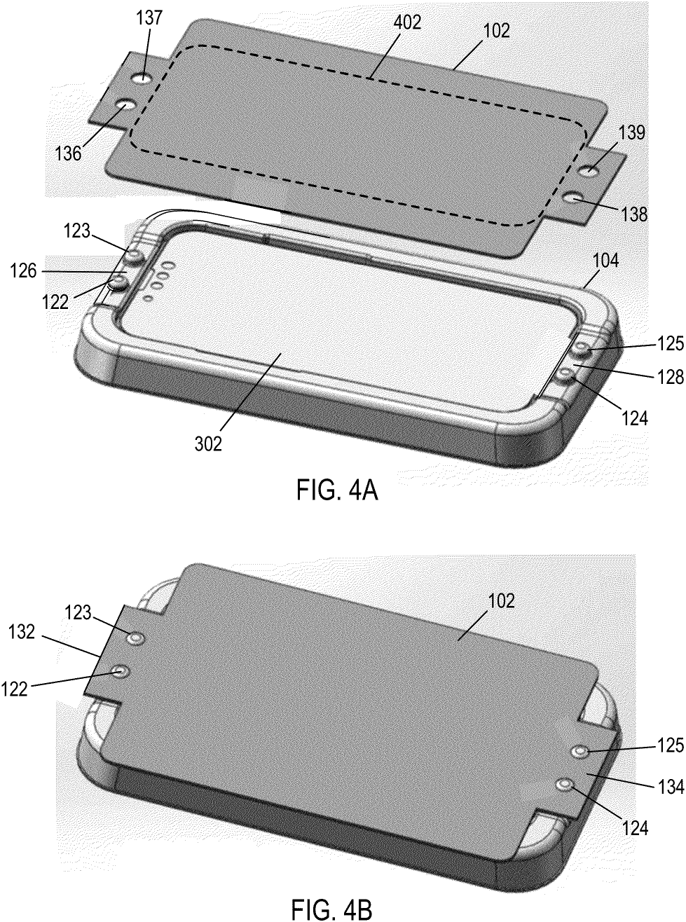

11)FIGS. 4A-4B show an example of attaching a screen protector to the touchscreen of the mobile phone using the applicator.

### DETAILED DESCRIPTION

This disclosure presents installation tools for attaching screen protectors, decals, and other objects to the surfaces of mobile devices. The mobile devices include mobile phones, tablet computers, and mobile phone cases. The installation tools prevent the inaccurate manual installation of screen protectors to touchscreens of mobile devices or inaccurate installation of decals to a case for a mobile device or to the back of a mobile device. The installation tools are composed of biodegradable materials that can be composted rather than discarded in the trash when the useful life of the installation tool is complete. For example, components of the installation tools are made of compostable materials, such as sugarcane pulp and/or bamboo pulp, or biodegradable plastics.

12)The drawings described below illustrate an example installation tool and how the example installation tool is used to apply a screen protector to a touchscreen of a mobile phone. In other implementations, the installation tool can be configured to apply a screen protector to a touchscreen of a tablet or to apply a decal to the back of a mobile device or a case of a mobile device.

13)FIG. 1A shows an isometric view of an example installation tool 100. The installation tool 100 includes an applicator 102 and an installation tray 104. FIG. 1B shows a cross-sectional view of the installation tray 104 along a line A-A in FIG. 1A. FIG. 1C shows a cross-sectional view of the installation tray 104 along a line B-B in FIG. 1A. FIGS. 1A-1C reveal that the installation tray 104 is formed from a single piece of material with an outer wall 106, a ledge 108, an inner wall 110, and a floor 112. The inner wall 110 and floor 112 are shaped to create a form-fitting container 114 for holding a particular type of mobile phone, such as a particular cell brand of mobile phone. The inner wall 110 may include one or more indentations and the floor 112 may include one or more recesses for receiving protuberances, such as buttons located along the edge of the mobile phone and camera lenses located along the back of the mobile phone. In FIGS. 1A and 1B, the inside wall 110 includes indentations 116 and 118 for receiving protuberances located on opposite edges of the mobile phone and a recess 120 in the floor 112 for receiving an array of camera lenses that protrude from a surface of the mobile phone. In FIGS. 1A and 1C, the installation tray 104 includes four positioning posts 122-125 located in opposing recessed segments 126 and 128 of the short sections of the edge 108. The floor 112 includes an opening 130 that enables a user to push a mobile phone out of the container 114 by inserting the user’s finger into the opening 130.

14)In FIG. 1A, the applicator 102 includes tabs 132 and 134 that extend from the short edges of the applicator 102. In this example, each tab includes two alignment holes. Tab 132 includes alignment holes 136 and 137. Tab 134 includes alignment holes 138 and 139. The tabs 132 and 134 are dimensioned so that the tabs 132 and 134 fit within corresponding recessed segments 126 and 128 of the installation tool 104. The alignment holes 136-139 are aligned with the positioning posts 122-125 and the positioning posts 122-125 are dimensioned to pass through the corresponding alignment holes 136-139. For example, the lengths of the tabs 132 and 134 are slightly smaller than the lengths of the recessed segments 126 and 128 and the diameters of the positioning posts 122-125 are slightly smaller than the diameters of the alignment holes 136-139.

15)FIG. 2 shows an example side elevation view of the applicator 102. In this example, a screen protector 202 adheres to the bottom surface 204 of the applicator 102 with a retaining adhesive 206. The screen protector 202 can be composed of any suitable transparent material, including tempered glass, urethane, polyurethane, polymethyl, methacrylate, or polycarbonate. The retaining adhesive 206 can be any suitable adhesive that does not leave an adhesive residue on the screen protector 202 and permits the screen protector 202 to be easily disengaged from the applicator 102. An installation adhesive 208 is applied to the placement surface of the screen protector 202. The installation adhesive 208 adheres the screen protector 202 to a touchscreen of the mobile phone and is a stronger adhesive than the retaining adhesive 206. A release liner (not shown) that covers the installation adhesive 208 may be used to protect the adhesive properties of the installation adhesive 208 until the screen protector is ready to be installed.

16)The retaining adhesive 206 can be composed of a fugitive adhesive, a hot melt adhesive, a pressure-sensitive adhesive, or a combination thereof. For example, the pressure-sensitive adhesive can be an acrylic-based polymer, acrylic emulsion polymer, natural elastomeric polymer, synthetic elastomeric polymer, elastomeric copolymer microsphere, vinyl ether, silicone, or combinations thereof.

17)The installation adhesive 208 can be, but is not limited to, a pressure-sensitive adhesive, such as acrylic-based polymers, acrylic emulsion polymers, natural elastomeric polymers, synthetic elastomeric polymers, elastomeric copolymer microspheres, vinyl ethers, silicone, or combinations thereof. Suitable pressure-sensitive adhesive materials can contain, for example, a polymer as a principal constituent, such as acrylic-type polymers, block copolymers, natural or recovered rubbers, styrene-butadiene rubbers, ethylene and vinyl acetate random copolymers, ethylene vinyl acrylic terpolymers, and polyisobutylene poly(vinyl ethers). Elastomeric polymers that may be incorporated in the adhesive include natural rubber (polyisoprene), polybutadiene, synthetic polyisoprene, random styrene-butadiene polymers, styrene-butadiene block copolymers, multiarmed and repeating (SB) copolymers, styrene-butadiene-styrene block copolymers, styrene-isoprene block copolymers, styrene-isoprene-styrene block copolymers, multiarmed styrene-isoprene, and block copolymers.

18)In another implementation, the retaining adhesive 206 and the installation adhesive 208 can be composed of biodegradable adhesives. For example, the retaining adhesive 206 and the installation adhesive 208 can be composed of adhesives that include starches (e.g., corn starch, potato starch, sugarcane, and wheat starch), resins (e.g., gum arabic), casein or milk protein, and other animal sources (e.g, beeswax, shellac, and gelatin rendered from animals).

19)The installation tray 104 is formed from a signal piece of material that is configured to fit the shape and protuberances of a mobile phone 302. FIGS. 3A-3B show an example of placing mobile phone 302 into the form-fitting container 114 of the installation tray 104. As shown in FIG. 3B, the form-fitting container 114 is shaped and dimensioned to receive the mobile phone 302.

20)FIGS. 4A-4B show the placement of the applicator 102 onto the installation tray 104 to attach the screen protector 202 to the touchscreen of the mobile phone 302. In FIG. 4A, the applicator 102 is placed above the installation tray 104 with the screen protector 202, identified by dashed rectangle 402, attached to the bottom surface of the applicator 102, as described above with reference to FIG. 2, facing the touchscreen of the mobile phone 302. The applicator 102 is positioned so that the alignment holes 136-139 are aligned with the positioning posts 122-125 of the installation tray 104. In FIG. 4B, the applicator 102 is placed on the installation tray 104 such that the positioning posts 122-125 pass through the corresponding alignment holes 136-139, and the tabs 132 and 134 rest on the corresponding recessed segments 126 and 128 of the installation tray 104. A user applies pressure on the top surface of the applicator 102, thereby bonding the screen protector 202 to the touchscreen of the mobile phone 302 via the installation adhesive 208. The applicator 102 may be pulled away using one of the tabs 132 and 134, leaving the screen protector 202 adhered to the touchscreen of the mobile phone 302. As the applicator 102 is pulled away, the installation adhesive 208 adheres the screen protector 202 to the touchscreen while the retaining adhesive remains 206 is adhered to the applicator 102.

21) Implementations are not limited to an applicator having two alignment holes in each of the two tabs and an installation tray having two positioning posts located in recessed segments at opposite ends of the installation tray as described above. In another implementation, the positioning posts may be located within recessed segments of the long sections of the ledges of the installation tray. The applicator is configured with tabs and alignment holes that match the locations of the positioning posts of the installation tray. In other implementations, the applicator may have fewer than four alignment holes or more than four alignment holes and the corresponding installation tray may have fewer than four positioning posts or more than four positioning posts to match the alignment holes of the applicator. For example, the applicator may have only one alignment hole in each tab and the installation tray may have only one positioning post in each recessed segment of the ledge of the installation tray for receiving the tabs and insertion of the positioning posts in the corresponding alignment holes. In other implementations, the applicator may have four tabs with each tab located along the edge of the planar surface of the applicator and each tab having one or more alignment holes. The installation tray has four recessed segments in the ledge of the installation tray and is dimensioned to receive the four tabs and each recessed segment has one or more positioning posts that match the one or more alignment holes of the tabs.

22)The installation tool is not limited to applying screen protectors to the touchscreens of mobile phones. In other implementations, the installation tray can be configured to hold a mobile phone or a tablet with the touchscreen face down and the applicator of the installation tool can be configured to apply decals and other objects to the back surface of the mobile phone or tablet. In another implementation, the installation tray can be configured to hold a mobile device case and the applicator of the installation tool can be configured to apply decals and objects to the back surface of the mobile device case.

23)The installation tool and the screen protector, decal, or other objects to adhere to a mobile device can be packaged together into a kit. For example, the applicator 102 screen protector 202, retaining adhesive 206, installation adhesive 208, and the installation tray 104 can form a kit that is used to install the screen protector 202 to a touchscreen of a mobile phone as described above with reference to FIGS. 4A-4B.

24)The applicator and tray of the installation tool are produced by automated machine molding and die-cutting using a precision fixture to ensure accurate dimensions, acting as installation and part of the holder/container in the package. Alternatively, the installation tool can be made using a wet compression molding process, then die-cutting and pressed to form a container for a mobile phone using a precision fixture.

25)The applicator and the installation tray are made of a decomposable material that can be completely biodegraded and composted, thereby eliminating the need to dispose of the installation tool in the trash after use. In one implementation, the applicator and the installation tray are composed of sugarcane pulp. In another implementation, the applicator and the installation tray are composed of bamboo pulp.

26)In other implementations, the applicator and installation tray are composed of a combination of sugarcane pulp and bamboo pulp, such as the applicator and installation may be composed of X% sugarcane pulp (bamboo pulp) and the installation tray is composed of 100 - X% bamboo pulp (sugarcane pulp). In one implementation, the applicator and the installation tray are composed of about 50% sugarcane and about 50% bamboo pulp. In another implementation, the applicator and installation tray are composed of about 40% sugarcane and about 60% bamboo pulp. In another implementation, the applicator and installation tray are composed of about 40% bamboo pulp and about 60% sugarcane pulp. In another implementation, the applicator and installation tray are composed of about 30% sugarcane pulp and about 70% bamboo pulp. In another implementation, the applicator and installation tray are composed of about 30% bamboo pulp and about 70% sugarcane pulp. In another implementation, the applicator and installation tray are composed of about 20% bamboo pulp and about 80% sugarcane pulp. In another implementation, the applicator and installation tray are composed of about 20% sugarcane pulp and about 80% bamboo pulp. In another implementation, the applicator and installation tray are composed of about 10% bamboo pulp and about 90% sugarcane pulp. In another implementation, the applicator and installation tray are composed of about 10% sugarcane pulp and about 90% bamboo pulp.

27)In still other implementations, the applicator is composed of one combination of sugarcane and bamboo pulp described above, and the installation tray is composed of a different combination of sugarcane and bamboo pulp described above.

28)In still other implementations, the applicator and installation tray may be composed of other types of biodegradable materials, such as biodegradable plastic. Examples of biodegradable plastics include but are not limited to, polyhydroxalkanoates, a thermoplastic aliphatic polyester, or thermoplastic polymers produced by blending starch with plasticizers.

29)It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein

1. An installation tool comprising:
an applicator having a planar surface for attaching an object to a surface of a mobile device and two or more tabs, each tab having one or more alignment holes; and
an installation tray having an inner wall and a floor shaped and dimensioned to form a container for the mobile device, and a ledge surrounding the container and having two or more recessed segments for receiving the two or more tabs, each recessed segment having one or more positioning posts that are dimensioned to pass through the one or more alignment holes, wherein the applicator and installation tray are composed of biodegradable materials.

2. The installation tool of claim 1 wherein the biodegradable materials comprise sugarcane pulp.

3. The installation tool of claim 1 wherein the biodegradable materials comprise bamboo pulp.

4. The installation tool of claim 1 wherein the biodegradable materials comprise a combination of sugarcane pulp and bamboo pulp.

5. The installation tool of claim 1 wherein the biodegradable material of the applicator comprises a first combination of sugarcane pulp and bamboo pulp and the installation tray comprises a second combination of sugarcane pulp and bamboo pulp.

6. A kit for installing an object to a mobile device, the kit comprising:
an applicator composed of a first biodegradable material having a planar surface and two or more tabs extended outward from the planar surface, each tab having one or more alignment holes;
a retaining adhesive disposed on the planar surface, the retaining adhesive attaching the object to the planar surface of the applicator;
an installation adhesive disposed on the object; and
an installation tray composed of a second biodegradable material and having an inner wall and a floor shaped and dimensioned to form a container for the mobile device, and a ledge surrounding the container and having two or more recessed segments for receiving the two or more tabs, each recessed segment have one or more positioning posts that are dimensioned to pass through the one or more alignment holes.

7. The kit of claim 1 wherein the first biodegradable material comprises sugarcane pulp or bamboo pulp.

8. The kit of claim 1 wherein the second biodegradable material comprises sugarcane pulp or bamboo pulp.

9. The kit of claim 1 wherein the first biodegradable material comprises a first combination of sugarcane pulp and bamboo pulp and the second biodegradable material comprises a second combination of sugarcane pulp and bamboo pulp.

10. The kit of claim 1 wherein the biodegradable material of the applicator comprises a first combination of sugarcane pulp and bamboo pulp and the installation tray comprises a second combination of sugarcane pulp and bamboo pulp.

11. The kit of claim 1 wherein the retaining adhesive and the installation adhesive are composed of biodegradable adhesives.
